(19) United States
(12) Patent Application Publication
(10) Pub. No.: US 2012/0235879 A1
(43) Pub. Date: Sep. 20, 2012

(54) THREE DIMENSIONAL ANTENNA

(75) Inventors: Andreas Eder, Regensburg (DE); Wilfried Hedderich, Hilden (DE); Thomas Wagner, Hasselroth (DE); Mads Sager, Roskilde (DK)

(73) Assignee: Molex Incorporated, Lisle, IL (US)

(21) Appl. No.: 13/265,154

(22) PCT Filed: Apr. 14, 2010
(86) PCT No.: PCT/US10/31066

§ 371 Date: May 3, 2012

Related U.S. Application Data
(62) Division of application No. 61/171,110, filed on Apr. 21, 2009.

(51) Int. Cl. H01Q 1/12; H01Q 1/40

(52) U.S. Cl. 343/873; 343/872; 343/878; 29/600

(57) ABSTRACT

An antenna shape can be inked onto a thin film and then the thin film can be shaped to form a three dimensional (3D) flex-film. The 3D flex-film can then be integrated into a carrier using conventional molding processes. The resultant housing includes a carrier that supports the 3D flex-film on an inner or outer surface of the carrier. The resultant housing thus allows for improved integration of an antenna with a housing so as to provide a more desirable housing for devices that can benefit from the corresponding antenna, such as, but not limited to, mobile devices.

This application claims priority to U.S. Provisional Application No. 61/171,110, filed Apr. 21, 2009, which is incorporated herein by reference in its entirety.

### BACKGROUND OF THE INVENTION

1. Field of the Invention

The present invention relates to the field of antennas, more specifically to the field of antennas suitable for use in devices that include a housing.

2. Description of Related Art

For more than a decade internal antennas have been the preferred solution for mobile wireless devices. The internal antennas can be integrated with a housing of the mobile phone, laptop, gaming console or the like. With the latest technology in active impedance tuning- and matching techniques, these electrically small antennas can be designed to cover radio frequency (RF) protocols in the range from RFID (13 MHZ) to Ultra-wideband (UWB) ending at about 10.6 GHz. Most internal antennas, however, operate in the GSM and UMTS cellular bands widely used in mobile phones and laptops.

In the wireless market place there is a continuous drive to make devices smaller. However, the laws of physics limit how small an integrated antenna can be made and still have efficient radiation properties. In order to obtain the desired space for the integrated antenna and still keep the total product size small it is desirable to place the antenna in the outmost corner of the housing of the wireless device. This can be achieved with an antenna that is formed in a three dimensional (3D) shape fitting to the contours of the inside of the housing, e.g. an internal 3D antenna.

Recent internal 3D antennas are primarily realized by flexible circuit print (FCP) antennas, metal sheet antennas, and Laser Direct Structure (LDS) antennas. Each method has its strengths and weaknesses. The FCP antenna, such as disclosed by U.S. Pat. No 6,778,139, typically involves a thin plastic layer that supports a foil-based antenna design. The FCP antenna allows the antenna to be bent but does not allow for a full 3D antenna technology. For example, the FCP antenna cannot be bent over a double-curved surface and is limited in its ability to follow the topology of a surface, particularly around sharper bends. This limits FCP antenna placement on organic shapes and certain corners. The metal sheet antenna is also limited to sections of flat metal surfaces and by the amount of bends it is possible to make on the antenna from a manufacturing point of view.

The LDS antenna technology is perhaps the most flexible of the three methods. With LDS technology, an antenna pattern is shaped with a laser on a plastic surface, and the energy provided by the laser allows the excited area to be subsequently plated with metal. The LDS technology allows for a full 3D antenna topology but only certain plastic materials can be used and the possible plastics tend to have certain material properties that can make the available housings less desirable for use as the housing of the wireless device. For example, LCP (liquid crystal polymer), which is a common type of plastic used for LDS technology, generally does not provide a Class A surface when treated with LDS technology but instead might require post-operative steps. Furthermore, the plastic used for LDS technology must be first formed, then excited by the laser and then plated (itself often a multi-step process). Thus manufacturing cycle times can be problematic. Hence, LDS technology tends to add undesirable cost to the design and the antenna might not be realized on the inside of the housing but instead require a separate part inside the device. Consequentially, further improvements in antenna technology would be appreciated.

### BRIEF SUMMARY OF THE INVENTION

A three-dimensional flex-film is provided and includes a thin-film with dimensions that substantially match one of an intended interior or exterior surface of a carrier. The film includes a thin-film antenna array. A carrier is provided with an interior or exterior surface that includes one or more curves and forms a geometrical, three-dimensional shape that matches the three-dimensional flex-film. The carrier and the flex-film are integrated to form a housing. In an embodiment, the integration can be accomplished by in-mold labeling.

In an embodiment, the housing may include multiple layers and the flex-film may be positioned between two layers. The housing may further include a decorative label that forms at least part of a Class A surface. In an embodiment, the label may be integrated with the three-dimensional flex-film so that the antenna array is positioned on one side of a film and is facing toward the carrier and a decorative label is positioned on the other side of the film. In another embodiment, there may be two films, one support a decorative label and one supporting the antenna. The label may be positioned on the exterior side of the housing and the antenna array may be positioned on the interior side of the housing. In an embodiment with a sandwiched antenna array or with an antenna array on the exterior side of the housing, the carrier (or one its layers, as appropriate) may include one or more apertures so that the conductive members may extend through the aperture(s) to make electrical contact with the antenna.

### BRIEF DESCRIPTION OF THE DRAWINGS

The present invention is illustrated by way of example and not limited in the accompanying figures in which like reference numerals indicate similar elements and in which:

FIG. 1 illustrates a perspective view of an embodiment of a housing that includes a three-dimensional flex-film on an inner surface.

FIG. 1A illustrates a perspective close-up view of an embodiment of a housing that includes a three-dimensional flex-film on an inner surface.

FIG. 1B illustrates a perspective view of another embodiment of a housing that includes a three-dimensional flex-film on an inner surface.

FIG. 2 illustrates a perspective view of an embodiment of a housing that includes a three-dimensional flex-film sandwiched between two layers.

FIG. 2A illustrates a perspective enlarged view of the embodiment depicted in FIG. 2.

FIG. 3 illustrates a perspective view of another embodiment of a housing that includes a three-dimensional flex-film sandwiched between two layers.

FIG. 3A illustrates another perspective view of the embodiment depicted in FIG. 3.

FIG. 3B illustrates a perspective enlarged view of the embodiment depicted in FIG. 3.

FIG. 4 illustrates a perspective view of an embodiment of a housing that includes a three-dimensional flex-film on an inner and outer surface.

FIG. 4A illustrates another perspective view of the embodiment depicted in FIG. 4.

FIG. 4B illustrates a perspective close-up view of the embodiment depicted in FIG. 4.

FIG. 5 illustrates a perspective view of another embodiment of a housing that includes a three-dimensional flex-film sandwiched between two layers.

FIG. 6 illustrates an embodiment of a method suitable for use in forming a three-dimensional flex film.

FIG. 7 illustrates an embodiment of a formed three dimensional flex film.

### DETAILED DESCRIPTION OF THE INVENTION

The detailed description that follows describes exemplary embodiments and is not intended to be limited to the expressly disclosed combination(s). Therefore, unless otherwise noted, features disclosed herein may be combined together to form additional combinations that were not otherwise shown for purposes of brevity.

As disclosed herein, embodiments can provide a full three dimensional (3D) antenna technology, which does not have certain limitations of the FCP, metal sheet or LDS antennas. The presented antenna technology, which may be referred to as 3D-flex, is a modified printed antenna, which is pre-formed to fit a 3D surface. The 3D forming is not limited to a single-curved surface or to a straight surface and the film can be placed on any material. As an example the 3D-flex can be insert-molded or over-molded to the housing of the wireless device and thereby utilize the outmost corners of the device. As depicted herein, a plastic housing can be configured to include a three-dimensional (3D) antenna structure and the antenna structure can be mechanically integrated into the plastic housings by using a 3D formed flexible film. For example, the antenna structure can be geometrically fitted to the inner or outer surface of a housing, which may be plastic or a combination of different materials, as desired. In an embodiment this fitting to the housing can be accomplished by over-molding or insert-molding a 3D formed flexible film to the housing. The flexible film, in turn, carries the antenna array structure.

It should be noted that while an antenna could be configured for a wide range of frequencies. In an embodiment the frequency range of the antenna(s) in the antenna array may be between about 13 MHz (such as is suitable for RFID applications) and about 10.6 GHz (such as would be suitable for ultra wide band “UWB” applications). Other frequencies outside the ranges are also contemplated. In a preferred embodiment the frequency range of the antenna(s) lies between 13 MHz and 14 MHz. In another preferred embodiment the frequency range of the antenna(s) lies between 76 MHz and 239.2 MHz. In another preferred embodiment the frequency range of the antenna(s) lies between 470 MHz and 796 MHz. In another preferred embodiment the frequency range of the antenna(s) lies between 698 MHz and 2690 MHz. In another preferred embodiment the frequency range of the antenna(s) lies between 3400 MHz and 5850 MHz. In another preferred embodiment the frequency range of the antenna(s) lies between 3.1 GHz and 10.6 GHz. As can be further appreciated, an antenna array may include multiple antennas, each configured to function in a different range.

It should be noted that while the embodiments depicted are suitable for common (electronic) mobile devices such as mobile phones, PDAs, portable game systems like gaming consoles, notebooks, laptops, and netbooks, the features depicted are not so limited but instead may be broadly applied to other devices that include or would benefit from an antenna. It should further be noted that a wide range of housings configuration may be used in conjunction with the features disclosed herein. Therefore, the features disclosed may be used with other devices where it would be desirable include a 3D antenna formed on a surface of a housing.

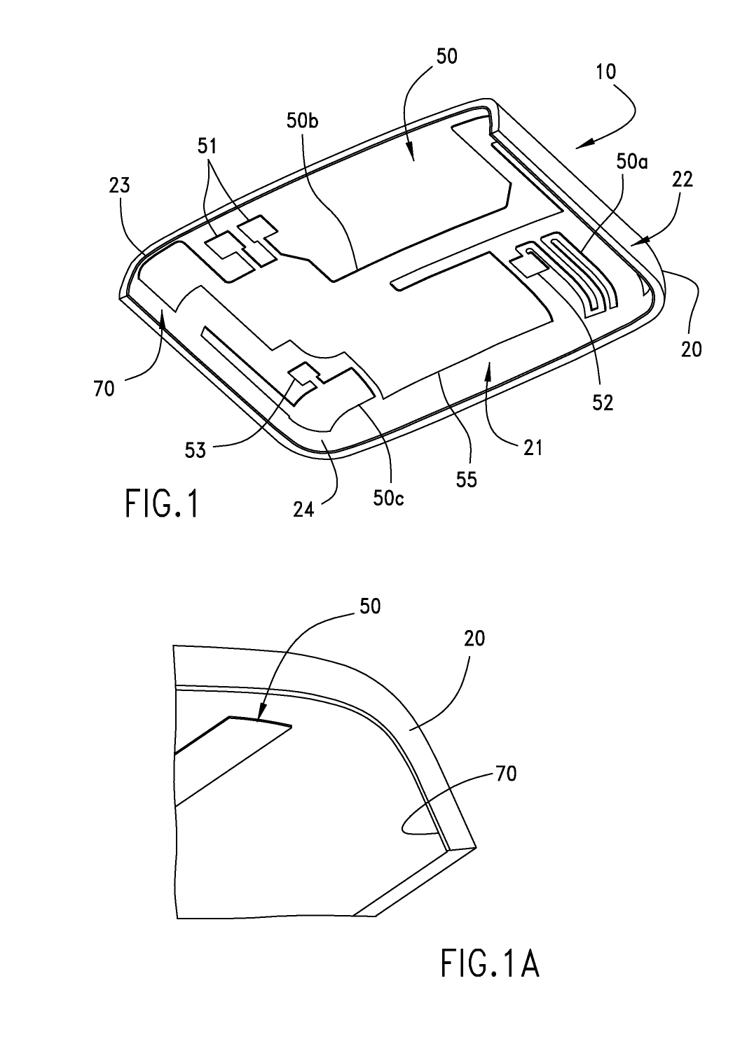

Turning to the Figures, FIGS. 1-5 illustrates embodiments that represent possible structures that can be formed. FIGS. 1 and 1A are representative of a first embodiment. A housing 10 includes a carrier 20, which may be formed of any desirable materials, such as conventional moldable materials used to form housings used in mobile devices and may be a composite formed of different types of materials. The carrier 20 includes an inner surface 21 and an outer surface 22 and further includes a curved surface 21 and a corner 24 that couple inner surfaces that are position in planes and are angled with respect to each other with a relatively small radius (the limits of the radius can be based on the method of forming the carrier 20). While the depicted carrier 20 has a relatively simple structure, it can be appreciated that a inner surface 21 and the outer surface 22 can include any number of curves and corners so as to provide the desired carrier structure. Furthermore, features of the inner and outer surface 21, 22 can be related or can be independent of each other. For example, a relatively substantial depression in one of the inner or outer surface would necessarily be present in the other of the inner and outer surface. However, the outer surface 22 might have a relatively smooth surface with only curves over its entire area while the inner surface 21 might include corners and notches and bosses and the like so as to provide additional space or to provide retaining features for components that will be positioned adjacent the inner surface 21.

Thus, the housing 10 could have any conventional shape and include any number of conventional shapes formed in the carrier based on known forming methods. Furthermore, as is known, the housing 10 could include various features that were insert molded into the housing 10. These differences in the inner surface 21 and the outer surface 22, as well as wide range of possible geometric shapes, can be provided in the other depicted embodiments discussed below but as the forming of housing with different shapes is known, the different shapes will not be further discussed for purposes of brevity.

Positioned on the inner surface 21 is a flex-film 70, which can be formed of a desirable material such as a film of plastic material, e.g. of one plastic material or a blend of plastic materials like (without limitation) PET (polyethylene terephthalate) PEN (polyethylene naphthalate), PC (polycarbonate), ABS (acrylnitrile butadiene styrene) and PI (polyimide). The material used to form the flex-film 70 can be selected so that the flex-film 70 retains its shape once it is formed into a 3D shape. In an embodiment, the flex-film 70 can be formed first and then integrated into the carrier 20 using conventional molding processes such as in-mold labeling (IML). Thus, the flex-film 70 has a 3D shape prior to integration and once integrated into the carrier 20 can provide a housing 10 that includes the flex-film 70 and the carrier 20 in a laminate-like configuration. The thickness of the film is in between 50 μm and 500 μm, preferably between 75 μm and 375 μm, most preferably between 125 μm and 250 μm.

Positioned on the flex-film 70 is an antenna array 50 that as depicted includes a first antenna 50a, a second antenna 50b and a third antenna 50c, each of which have a body 55 and contacts 51, 52, 53. As can be appreciated, certain antenna designs may include a single-feed design (and thus require a single contact 53) while other antenna designs may includes a dual-feed design and include contacts 51. As can be further appreciated, the shape of the body 55 for each antenna in the antenna array 50 will depend on the intended use of the antenna. While the antenna array 50 may include a single antenna, it may also include some larger number of antennas, such as 4 or more antennas.

One feature that one of the antennas may have is an antenna formed around a curve and/or corner. For example, as depicted, antenna 50b includes a transition portion 58 that is formed on a curve. As can be appreciated, however, a majority of the inner surface 21 has at least a slightly curved surface, thus a substantial portion of the antenna 50b is 3D in shape. The 3D shape of the antenna 50b allows it to fit in the housing while taking maximum advantage of the space allowed. The transition portion 58 allows the antenna to continue over portions of the inner surface 21 that otherwise might be difficult to use with conventional antenna forming technology.

FIG. 1B illustrates another embodiment of a housing 10′ that includes a flex-film 70′ with an antenna array 50′ positioned on an inner surface 21′ of carrier 20′. As in FIG. 1, an outer surface 22′ is smooth and may provide a Class A surface while a number of contacts 51′, 52′, 53′ are provided along an edge 26′ of the carrier 20′. Thus, a number of possible design variations are possible with respect to the antenna array 50′ and the corresponding contacts 51′, 52′, 53′. The selected configuration will vary depending on how contact with the antenna array is desired. For example, in FIG. 1, the contacts 51, 52, 53 are suitable for pogo pin like contacts while the contacts in FIG. 1B are suitable for clips such as C clips. As can be appreciated, some contacts may be configured for one contact method while other contacts are suitable for another contact method.

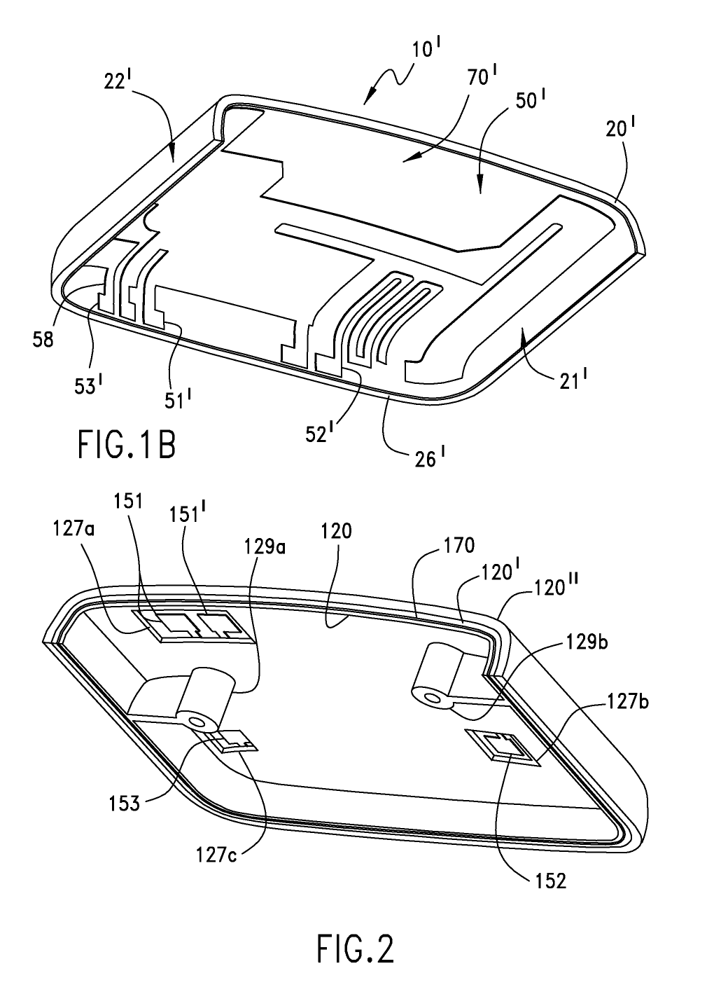

FIGS. 2-3B and 5 illustrate embodiments with multiple layers of carriers sandwiched around an antenna array and flex-film. For example, FIGS. 2-2A illustrate an inner carrier 120, a second carrier 120′ and an outer carrier 120″. Positioned between carrier 120 and 120′ is a flex-film 170 that includes an antenna array (which may be similar to the antenna arrays depicted in FIG. 1 or 1B or may have some other desirable configuration of one or more antennas). Apertures 127a, 127b, 127c expose contacts 151, 151′, 152, 153 so that, for example, a pogo pin can electrically couple to the contacts. As depicted, the apertures are only in the inner carrier 120 and the two carriers 120′, 120″ provide reinforcement to resist deformation when the forced is exerted on the contacts. It should further be noted that the apertures 127a, 127b, 127c have edges that provide a parameter that extends fully around the contacts. While not required, the parameter edge can be used to help position a corresponding element that is configured to engage the contact positioned in the aperture. Furthermore, as can be appreciated, an aperture can enclose a single contact or multiple contacts.

To support the housing, the inner carrier 120 further includes bosses 129a, 129b that can be used to receive fasteners. Thus, while the outer surface of the carrier 120 substantially matches the inner surface of the carriers 120′, 120″, the inner surface of the carrier 120 includes bosses 129a, 129b and does not match.

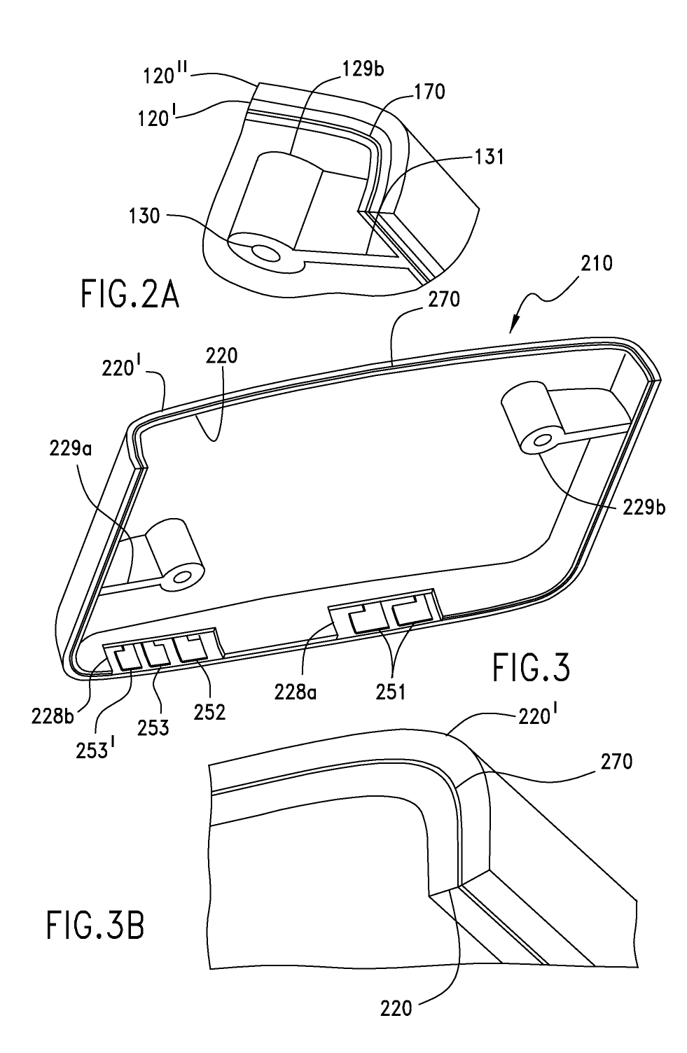

FIGS. 3-3B illustrate an embodiment of a housing 210 that includes a flex-film 270 sandwiched between carrier 220 and carrier 220′. The carrier 220 may include bosses 229a, 229b and include apertures 228a, 228b that are notch-shaped and lack an edge that extends around a parameter of contacts 251, 252, 253, 253′. The apertures 228a, 228b are beneficial in that they both provide access to multiple contacts as this can help simply the design of the opposing contacts.

As can be appreciated from FIG. 3A, the carrier 220′ is transparent and therefore an antenna array 250 is visible. A carrier can have the desired level of transparency (from fully transparent to opaque) and may include portions that have different levels of transparency (as well as different colors). In certain circumstances, for example, it may be desirable to allow a portion of an antenna pattern be visible so as to enhance visual appeal of the housing to certain people. Furthermore, certain applications may use a standard antenna and the inclusion of such an antenna in the antenna array may provide a desirable marketing advantage if it is made visible to the end user of the housing.

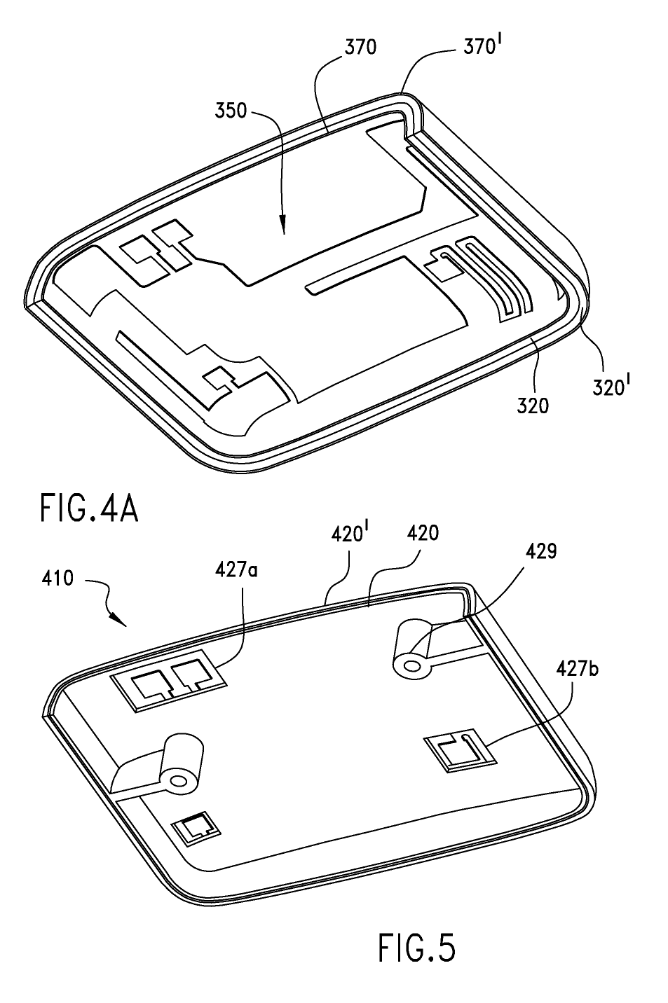

FIG. 5 illustrates an embodiment with a carrier 420 and an over-mold 420′ that sandwich a flex-film 470 that again supports an antenna array with contacts positioned in apertures 427a, 427b. Thus, the number of carriers can be varied depending on structure requirements and the intended use of the housing. Bosses 429, which are optional, can be included if a fastener is intended to secure the housing 410 to another component (not shown).

The over-mold 420′ can be any desirable plastic and can provide a Class A surface. Furthermore, it can be any desirable color and can have the desired level of opacity or transparency. It should be noted that while over-mold 320′ is depicted as having a substantial thickness similar to that of the carrier 320, in an embodiment the over-mold 320′ can be some other thickness, such as a thickness similar to that of the film 370. If the carrier 320 is used to provide the structural properties of the housing, then the over-mold 320′ need not be particularly strong but instead can be configured to provide the desired aesthetic appearance. However, as can be appreciated, the over-mold 340 can be any desired thickness. Thus, the 3D flex-film can be positioned between two layers. It should be noted that the over-mold 320′ could be used as the carrier (and provide the primary structural support) and the carrier 320 could be a reinforcement layer (including the depicted bosses for receiving fasteners or the like).

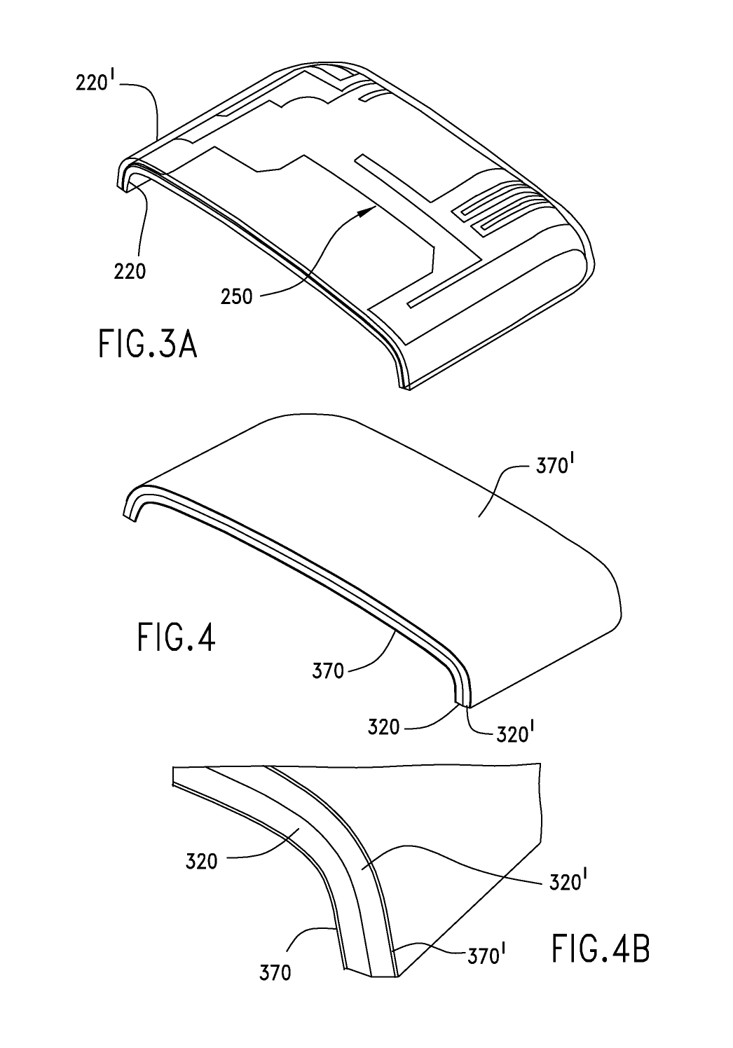

FIGS. 4-4B illustrate an embodiment with two flex-films 370, 370′ that are integrated on carriers 320, 320′, respectively. The flex-film 370 supports an antenna array 350 while the flex-film 370′ can provide a Class A surface. On benefit of using the flex-film 370′ to provide the class A surface is that it may allow the use of a material that is otherwise is difficult to use to provide a Class A surface. In addition, the label may provide graphics that would otherwise be extremely difficult to include on the carrier 320′ in a manner that would provide an acceptable measure of durability. Thus, a wide range of possible variations in housing structure are possible using various configurations depicted, alone or in combination. It should further be noted that if desired, different thin films could provide different antennas and a thin film could have an antenna on one side and a label on the other. Thus, while flex-film 370 is shown as including the antenna, in certain embodiments the flex-film 370′ could include one or more antennas (either instead of or in addition to any antennas in flex-film 370). Thus, the depicted structure provides substantial flexibility in designing a housing structure.

It should be noted that while a housing has been shown that might be suitable for use in a mobile device, the housing can take any desirable shape. In addition, as noted elsewhere, the features disclosed herein are suitable for a wide range of applications.

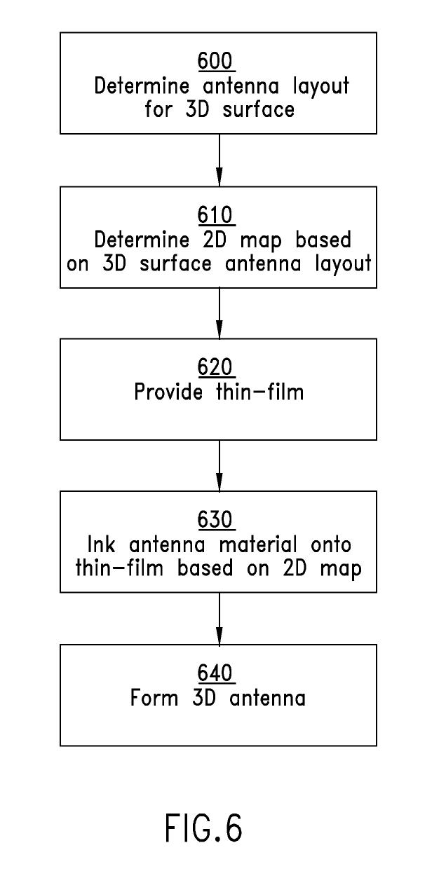

As noted above, a substantial range of housing structures are possible. As can be appreciated, this flexibility is facilitated by the method in which the 3D flex-film is formed. Looking at FIG. 6, a process for forming the 3D flex-film is described.

First in step 600, an antenna layout is determined This typically involves taking the intended 3D shape of the housing and determining how the antenna array should be positioned on the housing. Aspects that can be addressed in this process include determining how electrical contact to contacts are going to be provided as well as the intended operating frequencies of the antenna array, as well as the desired shape and size of the antenna array. Modeling software can be used to determine a layout that provides acceptable antenna performance.

Once the three-dimensional surface shape is determined in step 610, the three-dimensional shape is mapped to a two-dimensional shape taking in account the local elongation of the film by the forming process. This reverse transformation process can be accomplished using a number of known techniques like Simulation or finite element method to achieve a defined accuracy, that have to be fine tuned by experimental iteration with grid-printed- or antenna-printed-film, combined with known 2D/3D measurement and evaluation methods.

Next in step 620, a thin-film is provided. The size of the thin-film should be large enough to cover the intended size of the antenna. The thin-film can be any desirable material, including blends, of plastics such as Polyethylene terephthalate (PET), Polyethylene naphthalate (PEN), Polycarbonate (PC), Acrylonitrile butadiene styrene (ABS), Polyimide (PI). The film may have one, two or none Class A—surfaces. The film may have already a formable coating applied on one side which gives protection against abrasion or wear or which gives a specific haptic feeling. The film may be transparent or non-transparent/colored. Colored means that the film may have a color itself or at least a colored layer may be deposited on the film.

Next in step 630, the 2D antenna pattern is printed onto the film. Possible printing technologies include screen printing, gravure printing, flexo printing, engraving printing, pad printing, rotary printing, inkjet printing, as well as other well-known printing methods, whereby screen printing is the preferred method. The pattern can be electrically conductive materials that are printable pastes and/or inks with a metallic base (silver, copper, gold, aluminum, alloys and/or mixtures of these elements, nano particles of these elements, alloys itself) or printable pastes and/or inks based on intrinsically conductive polymers (e.g. Poly (3,4-ethylenedioxythiophene)poly (styrenesulfonate) (PEDOT:PSS)) or printable pastes and/or inks based on transparent conductive oxides (e.g. Indium tin oxide (ITO) or Aluminium-doped zinc oxide) or printable pastes and/or inks based on single wallet carbon nanotubes or multi wallet carbon nanotubes or graphene. The electrically conductive materials shall have a specific conductivity of between 10⁴ Siemens/meter (S/m) and 6.3×10⁷ S/m, preferable between 10⁵ S/m and 6.3×10⁷ S/m, most preferable between 10⁶ S/m and 6.3×10⁷ S/m. One preferable electrically conductive material is DUPONT 5064 Silver Conductor. Following the ink printing, an isolating and deformable cover-coat for corrosion protection of the 2D antenna pattern can be used. If the cover-coat is provided, the area for electrically connecting the antenna to electronics within the housing can remain uncovered. It should be noted that the layout for the cover-coat can be larger than the antenna pattern itself in order to provide overlapping protection. The isolating cover-coat could also be a printable paste and/or ink, such as, but not limited to, DUPONT 5018 or PRÖLL HTR.

Once the antenna shape (and if desired, cover-coat) is inked onto the thin-film, the thin-film can be formed into the desired 3-D shape in step 640. This can be accomplished via conventional 3D forming techniques that involve heat and/or pressure sufficient to cause the thin-film to set in the desired 3D shape. For example, High Pressure Forming (HPF) known from U.S. Pat. No. 5,108,539 or thermoforming or combinations of the two methods of the 2D plastic film, printed with the antenna structure into the desired 3D shape of the housing, as well of the desired 3D shape of the antenna structure. Of course, a combination of HPF and thermoforming or other well-known 3D forming technologies may also be used.

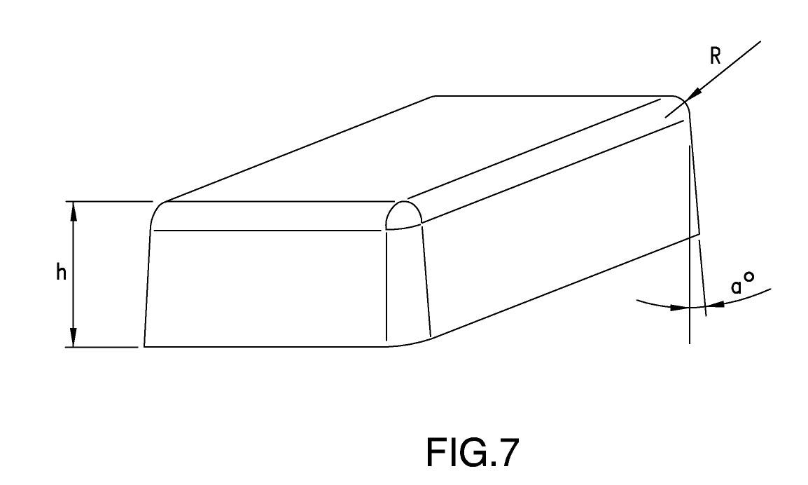

For example, one possible set of parameters for the forming process when a PC film like PC-Bayfol is used, are:
temperature of the film: 110 to 230° C., preferably 110 to 180° C.;
temperature of the forming tool: 60 to 170° C., preferably 60 to 140° C.;
applied pressure: 80 bar to 200 bar;
   With these parameters a time of cycle from 5 to 20 seconds can be achieved. It should be noted, as can be readily appreciated by one of skill in the art, that the temperature of the film and the temperature of the forming tool may have to be adjusted according to the softening temperature and the glass transition temperature of the film, if another material than PC is used. The applied pressure and the time of cycle may remain in the above mentioned limits By this method a 3D shape with the geometry of the 3D flex-film depicted in FIG. 7 can be achieved:
Radii (R) at edges: 0.2 to 40 mm, preferable 0.3 to 10 mm, more preferable 0.5 to 5 mm, most preferable 1 to 3 mm;
Forming height (h): 0 to 20 mm, preferable 0.5 to 5 mm, most preferable 1 to 3 mm;
Draft angle (a): 0 to 90°, preferable 1 to 5°, most preferable 2 to 3°.
   Due to the fact that the forming process is a 3D forming process the above described parameters are valid for corners, which can also be referred to as double bended edges.

The pastes and inks, as well as the cover coat, can be cured by using thermal (e.g., ovens), infrared- or microwave-based methods. If thermally curable, they can contain polymer binders as well as solvents or water. If the ink is UV-cureable, the ink may be hardened by a continuous or a pulsed UV-irradiation. It should be noted that the process of forming the 3D shape can also be used to cure the paste and or ink. In an embodiment, the inked on antenna can be partially cured first, then formed into the desired 3D shape before being cured the rest of the way.

Depending on the ink or paste used, it is possible to increasing the electrical conductivity of the 2D antenna pattern by compressing of the printed plastic film under an increased temperature, preferable between 20° C. and 250° C., more preferable between 100° C. and 180° C., most preferable between 120° C. and 150° C., and an increased pressure, preferable between 1 bar and 1000 bar, more preferable between 20 bar and 200 bar, most preferable between 50 bar and 100 bar.

The printed antenna pattern includes contacts and is generally configured to be in electrical communication with a transmitter/receiver. Conventional methods for contacting the antenna contacts can include pogo pins and/or clips. To improve electrical contact between the antenna contact and the corresponding connecting contact, a surface layer may be provided over the antenna contact area so that the contact area has a low surface roughness and provides good conductivity. The conductive surface layer could be a printable paste and/or ink based on carbon, carbon nanotubes, graphene, copper, silver, gold, alloys or mixtures of these elements, nano particles of these elements or alloys thereof. These pastes and inks can be cured by using thermal oven-based, infrared-based, microwave-based or UV-based methods. Possible printing technologies include screen printing, gravure printing, flexo printing, engraving printing, pad printing, rotary printing, inkjet printing, as well as other well-known printing methods.

Once the 3D flex-film is formed, it may be integrated with the carrier. In an embodiment, the 3D flex-film may be formed as part of the carrier using in-mold labeling (IML) so that a single integrated part is provided. The 3D flex-film can also be integrated into the carrier by insert-molding. As can be appreciated, if the 3D flex-film includes a Class A surface then it can be integrated so that it is on the outer surface of the carrier. Alternatively, if the 3D flex-film does not include a Class A surface, then it can be positioned between a carrier layer and another layer or on the inner surface of the carrier.

The 3D flex-film can include labels in certain portions while omitting the labels in other portions and can further include multiple layers. Thus, the 3D flex-film need not provide a uniform look on a particular surface and can be laminate in nature. For example, if desired an electroluminescent layer or image could be provided on a portion of the 3D flex-film. Thus, one or more labels could be positioned so that the one or more labels extend over all or only a portion of the 3D flex-film. Furthermore, certain areas can include pads applied by the use of conductive adhesives.

While IML is contemplated as a one method of integrating the 3D flex-film with the carrier, it should be further noted that in an embodiment the 3D flex-film could be integrated by the use of other conventional assembly methods (adhesives, ultrasonic welding, snap fits, heat staking or other joining methods). Conventional assembly methods may be more desirable when the 3d flex-film has multiple layers (for example , if the 3D flex-film has two layers—one is located on the outside for realizing a Class A—surface and the other one located on the inside for carrying the antenna pattern).

As can be appreciated, variations in the manufacturing process are possible. For example, a two molding process could be used, with one over-molding step and one insert-molding step, e.g. using a 2-shot molding process and tooling. A 3D flex-film could be insert-molded so as to be integrated with a carrier in the first step and then over-molded with another layer in a second step. Specific areas, such as contact areas, can avoid being covered by plastic during the first process step. The film may be supported by the second injected plastic material from the outside, especially in the contact area. This can help provide reinforcement that is beneficial for situations where the force from a pogo pin needs to be resisted.

As discussed above, the carrier may be a composite material that includes plastic and metal structure coupled together. Alternatively, the carrier may be entirely made of plastic. Thus, the disclosed features can be used with any desirable housing.

The present invention has been described in terms of preferred and exemplary embodiments thereof. Numerous other embodiments, modifications and variations within the scope and spirit of the appended claims will occur to persons of ordinary skill in the art from a review of this disclosure.

We claim:

1. A housing, comprising:
a carrier with an inner surface and an outer surface;
a thin-film formed to correspond to one of the inner and outer surface; and
an antenna array inked on the thin-film, wherein the thin-film and antenna array form a three dimensional (3D) flex-film that is integrated with the carrier on the corresponding surface.

2. The housing of claim 1, wherein the 3D flex-film is molded or adhered into one of the inner and outer surface of the carrier.

3. The housing of claim 1, wherein the 3D flex-film is positioned on the outer surface of the carrier, the housing further comprising an over-mold that covers the 3D flex film.

4. The housing of claim 3, wherein the antenna includes a contact and the carrier includes an aperture extending between the inner and outer surface, wherein the contact is positioned in the aperture.

5. The housing of claim 1, wherein the 3D flex-film includes a double bend and extends around a corner of the carrier.

6. The housing of claim 1, wherein the 3D flex-film includes at least one label that does not extend over the entire 3D flex-film.

7. The housing of claim 1, wherein the 3D flex-film includes at least two layers.

8. The housing of claim 1, wherein, the 3D flex-film has the following geometry:
Radii (R) at edges: 0.2 to 40 mm, preferable 0.3 to 10 mm, more preferable 0.5 to 5 mm, most preferable 1 to 3 mm;
Forming height (h): 0 to 20 mm, preferable 0.5 to 5 mm, most preferable 1 to 3 mm;
Draft angle (a): 0 to 90°, preferable 1 to 5°, most preferable 2 to 3°.

9. The housing of claim 1, wherein, the 3D flex-film has the following geometry:
Radii (R) at corners: 0.2 to 40 mm, preferable 0.3 to 10 mm, more preferable 0.5 to 5 mm, most preferable 1 to 3 mm;
Forming height (h): 0 to 20 mm, preferable 0.5 to 5 mm, most preferable 1 to 3 mm;
Draft angle (a): 0 to 90°, preferable 1 to 5°, most preferable 2 to 3°.

10. The housing of claim 1, wherein the frequency range of the antenna(s) lies between 13 MHz and 14 MHz.

11. The housing of claim 1, wherein the frequency range of the antenna(s) lies between 76 MHz and 239.2 MHz.

12. The housing of claim 1, wherein the frequency range of the antenna(s) lies between 470 MHz and 796 MHz.

13. The housing of claim 1, wherein the frequency range of the antenna(s) lies between 698 MHz and 2690 MHz, more preferable between 880 MHz and 2690 MHz.

14. The housing of claim 1, wherein the frequency range of the antenna(s) lies between 3.1 GHz and 10.6 GHz.

15. A method, comprising:
printing a two-dimensional antenna pattern on a thin-film;
forming the thin-film into a three dimensional (3D) flex-film; and
integrating the 3D flex-film with one of an inner and outer surface of a carrier.

16. The method of claim 15, wherein the forming is conducted by HPF or thermoforming or combination of HPF and thermoforming

17. The method of claim 16, wherein the forming comprises the following parameters:
temperature of the film: 110 to 230° C., preferably 110 to 180° C.;
temperature of the forming tool: 60 to 170° C., preferably 60 to 140° C.;

18. The method of claim 16, wherein an applied pressure during the forming is between 80 and 200 bar.

19. The method of claim 16, wherein a cycle time of the forming is between 5 and 20 seconds.

20. The method of claim 15, wherein the electrical conductivity of the 2D antenna pattern is increased by compressing of the printed plastic film under an increased temperature, preferable between 20° C. and 250° C., more preferable between 100° C. and 180° C., most preferable between 120° C. and 150° C., and an increased pressure, preferable between 1 bar and 1000 bar, more preferable between 20 bar and 200 bar, most preferable between 50 bar and 100 bar.

21. The method of claim 15, wherein the integrating comprises molding the 3D flex-film into one of the inner and outer surface.

22. The method of claim 15, wherein the placing of the two dimensional pattern comprises the step of determining the two dimensional pattern based on a desired three dimensional pattern.

23. The method of claim 15, wherein the printing comprises screen printing.

24. The use of the housing of claim 1 or obtainable by the method of claim 13 as a housing for common non-mobile electronic devices or common electronic mobile devices, especially for mobile phones, PDAs, portable game systems, gaming consoles, notebooks, laptops, netbooks, remote control systems or other communication systems like Bluetooth devices or wireless networks.
